(19) United States
(12) Patent Application Publication
(10) Pub. No.: US 2021/0020384 A1
(43) Pub. Date: Jan. 21, 2021

(54) CARBON MICROTUBE COMPOSITE FILM ELECTRODE

(71) Applicant: SABIC GLOBAL TECHNOLOGIES, B.V., Bergen OP Zoom (NL)

(72) Inventors: Yunyang LIU, Taiyuan (CN); Ihab N ODEH, Sugar Land, TX (US); Chengmeng CHEN, Taiyuan (CN); Lijing XIE, Taiyuan (CN); Fangyuan SU, Taiyuan (CN); Guohua SUN, Taiyuan (CN)

(21) Appl. No.: 16/639,491

(22) PCT Filed: Aug. 17, 2017
(86) PCT No.: PCT/CN2017/097921

§ 371 Date: Feb. 14, 2020

(30) Foreign Application Priority Data
Aug. 17, 2017 (CN) PCT/CN2017/097921

(51) Int. Cl. H01G 11/24; H01G 11/40; H01G 11/86

(52) U.S. Cl. CPC H01G 11/24; H01G 11/86; H01G 11/40

(57) ABSTRACT

Discussed herein is a porous carbon microtube (PCM)-based composite film electrode. The PCMs are fabricated using an activation process to form the porous surface of the microtubes that is made up of mesopores and micropores. The electrode is formed from a mixture of a 2-dimensional material such as graphene oxide (GO) and a plurality of PCM that self-assemble in response to mixing. The mixture is disposed on a membrane in a vacuum filtration apparatus to form a precursor film which is reduced to form the composite film electrode.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Capacitors are electrical components that store electrical energy and may be made up of two conductive surfaces or components that are separated by a dielectric component. Lithium-ion batteries are rechargeable hybrid electrochemical energy storage devices that use capacitors of two parallel electrodes disposed with a conductive material such as an electrolyte solution in between. Lithium-ion batteries may be employed in industrial applications for power backups as well as for consumer electronics including mobile communication devices.

### SUMMARY

In an embodiment, a method of fabricating carbon microtubes, comprising disposing a plurality of fibers in a vacuum furnace; subsequently, activating the plurality of fibers, wherein activating the plurality of fibers comprises combining the plurality of fibers with an aqueous solution to form a mixture; and forming, in response to the activating, a plurality of porous carbon microtubes, wherein each microtube of the plurality of porous carbon microtubes, is hollow, and comprises a porous surface. In an embodiment, the plurality of porous carbon microtubes comprise an average length from about 3 μm to about 300 μm, an average wall thickness from about 0.3 μm to about 0.7 μm, and an inner diameter from about 8 μm to about 14 μm. In an embodiment, the plurality of plant fibers comprise at least one of cotton, willow catkin, or kapok and the carbonizing comprises disposing the plurality of fibers in a furnace and holding the plurality of fibers in the furnace from 300° C. to 1100° C. about for about 0.5 hour to about 4 hours. In an embodiment, the aqueous solution comprises potassium hydroxide (KOH) or phosphoric acid and the activating further comprises holding the mixture from about 10 minutes to about 400 minutes from about 400° C. to about 1100° C. In an embodiment, a portion of the plurality of carbon microtubes comprises a centerline comprising at least one smooth curve and is not aligned along a central axis and each carbon microtube of the plurality of carbon microtubes comprises a plurality of mesopores and a plurality of micropores, wherein at least some of the mesopores of the plurality of mesopores are adjacent to and connected to at least some of the micropores of the plurality of micropores to form a network. Further in this embodiment, the activating the plurality of fibers comprises disposing the fibers in an aqueous solution in a predetermined mass ratio of fibers:solution from 1:1 to 1:10.

In an embodiment, a method of fabricating an electrode film, comprising: forming a mixture of a 2-dimensional material and a plurality of carbon microtubes, wherein the 2-dimensional material and the plurality of carbon microtubes self-assemble in response to mixing; forming, via vacuum filtration, a precursor film, by disposing the mixture on a membrane in a vacuum filtration apparatus; and reducing the precursor film to form the composite film. In the embodiment, forming the mixture comprises forming a mass ratio in the colloidal dispersion of the plurality of porous carbon microtubes: 2-dimensional material (m_{PCM}:m_{2D}) from about 0.1 to about 30.1, and the 2-dimensional material comprises graphene oxide (GO), and, in some embodiments, the mixture does not comprise a binder. In an embodiment, reducing the precursor film comprises immersing the precursor film in hydrogen iodide (HI), and, subsequent to the reducing, the composite film comprises a tensile strength from about 2.9 MPa to about 6.5 MPa. In another example, reducing the precursor film comprises: disposing the precursor film between at least two plates to form an assembly; and annealing the assembly. In an embodiment, the precursor film comprises a first weight and a first thickness and wherein the composite film comprises a second weight and the first thickness, wherein the second weight is from about 40% to about 60% of the first weight.

In an embodiment, a device comprising: a first electrode comprising a conductive, flexible, composite film comprising graphene oxide (GO) and a plurality of carbon microtubes, wherein the plurality of microtubes are hollow and comprise porous walls; and a second electrode; wherein an electrolyte solution, electrolyte solid, or a molten salt is disposed between the first plate and the second plate. In the embodiment, the first electrode comprises a thickness from about 50 microns to about 80 microns and a tensile strength from about 2.9 MPa to about 6.5 MPa.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIGS. 1A and 1A′ are partial schematic illustrations of example porous carbon microtubes fabricated according to certain embodiments of the present disclosure.

FIGS. 1B-1E are examples of shapes of porous carbon microtubes that may result from the fabrication of the porous carbon microtubes according to certain embodiments of the present disclosure.

FIG. 2 is a flowchart illustrating a method of fabricating a plurality of porous carbon microtubes according to certain embodiments of the present disclosure.

FIG. 3 is a flowchart illustrating a method of fabricating a composite electrode film from porous carbon microtubes according to certain embodiments of the present disclosure.

FIG. 4 is a partial schematic illustration of a capacitor comprising a composite film fabricated according to embodiments of the present disclosure.

FIG. 5 is a partial cross-section of section A-A from FIG. 4 of the capacitor shown in FIG. 4.

FIGS. 6A-6C are photographs of as-formed composite films according to various embodiments of the present disclosure.

FIGS. 7A-7H are scanning electron microscopy (SEM) images of as-formed composite films (e.g., prior to reduction) fabricated according to certain embodiments of the present disclosure.

FIG. 8 is a graph of a plurality of absorption-desorption curves of as-formed composite films fabricated according to certain embodiments of the present disclosure

FIG. 9 is a graph of a plurality of results of cycling films made via Examples 1-5 to illustrate the rate capability of the films fabricated according to certain embodiments of the present disclosure.

FIG. 10 illustrates the tensile strength in mega-pascals (MPa) of samples made via Examples 1-5 to illustrate the rate capability of the films fabricated according to certain embodiments of the present disclosure.

FIG. 11 is a graph of the volume absorbed v. relative pressure obtained from N₂ adsorption-desorption isotherm measurements.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Lithium-ion capacitors are hybrid capacitors where activated carbon is used as a cathode and where the anode may be a Li-doped carbon material. These 3 capacitors store electrocₕemical energy and may have a higher power density and improved safety over Li-ion batteries and a higher energy density over traditional capacitors, and may be used in applications such as wind power generation, photovoltaic power generation, energy recovery systems, and other applications that benefit from high energy and power densities as well as durability. In comparison, Li-ion batteries are rechargeable batteries that comprise electrodes or capacitors configured to charge and discharge lithium ions for a plurality of cycles. Lithium-ion batteries may be used in various industrial and household applications, including emergency power backups/uninterruptable power supplies, land and marine vehicle power and peripheral device power, solar power storage, mobile power packs for various personal mobile communication devices, as well as the batteries coupled to those mobile communication devices. Li-ion batteries may not be as efficient as Li-ion capacitors since the discharge in the battery creates an effect that may diminish the battery's capacity over time, leading to more frequent replacement of the batteries. In contrast, Li-ion capacitors can perform more than 100 times more discharge cycles than the batteries prior to failure, which may translate to increased operation life, less maintenance, and a lower cost to the owner(s) of Li-ion devices. Thus, improving the performance of anodes and/or cathodes, as well as the electrolyte solid/solution or molten salt disposed in between, may further improve the capacitor's function. As such, binder-free graphene/biomass-derived porous carbon microtube composite flexible film electrodes and the methods of manufacture thereof are discussed herein.

The film fabricated herein may be referred to herein as a “composite film,” and may be employed for capacitors or electrodes such as lithium-ion capacitor. The porous carbon microtubes discussed herein may range in size from 3 to 300 μm in length, from 0.3 to 0.7 μm in thick, and from 8 to 14 μm in its inner diameter, which may also be referred to as a hollow center. The porous carbon microtubes may be said to have a hierarchal structure in that naturally selected hollow microtubes combined with artificially created pore structures on both inner and outer walls, the combination of which increases the surface area as compared to non-porous and/or solid structures without hollow centers. Stated differently, the hollow microtubular morphology is derived from (and exists in) the natural form of the natural fibers or other biomass, whereas a plurality of micropores and a plurality of mesopores are formed via the activation, these pores may form on the inside surface and outside surface of each hollow microtube. The mesopores and micropores discussed herein are not present in the native (naturally occurring) biomass materials discussed herein.

These pores and networks of pore structures, discussed in detail below, may extend completely or through the walls of the porous carbon microtubes, and may be discreet, distinguishable pores and/or networks of pores that have joined together to form networks. That is, the walls comprising each carbon microtube are porous and therefore may allow some measure of gas, liquid, and/or charge associated with either medium to pass through. This hierarchal structure increases the surface area of the microtubes, and thus increases the active surface area of the resulting composite film. Using the systems and methods discussed herein to fabricate the porous carbon microtubes promotes retaining the geometries and dimensions of the parent fibers during the dispersion of the porous carbon microtubes with graphene oxide (“GO”) when a composite material is formed from the porous carbon microtubes and the GO. That is, the systems and methods discussed herein preserve the structural integrity of the porous carbon microtubes, preventing breakage of the structures during the self-assembly with the GO, as discussed in detail below. Graphene and graphene oxide may be referred to herein as two-dimensional or “2D” materials. Two-dimensional materials as discussed herein are a class of nanomaterials that, as fabricated, comprise a thickness of a single atomic layer or two atomic layers.

In an embodiment, a plurality of natural plant fibers may be used as raw materials to prepare the biomass-derived porous carbon microtubes (“PCM”) with a “large” specific area via a carbonization and activation process. The GO was ultrasonically dispersed in water to form stable colloidal dispersions prior to combination with the PCMs. In an embodiment, the colloidal dispersions had a mass ratio of m_{PCM}:m_{GO} from about 1: 0.1 to about 1:30. The sonication may occur from about 5 minutes to about 90 minutes and may use from about 100 W to about 1000 W. Subsequently, the plurality of PCMs was mixed with the above-mentioned graphene oxide colloidal dispersions, and the resultant mixture was filtered using vacuum filtration to produce a flexible composite film precursor. In an embodiment, the vacuum filtration comprises using a Millipore filter to produce the graphene/porous carbon microtubes flexible composite film precursor. As used herein, a “film precursor” may also be referred to as an “as-formed” film or as an “as-formed precursor” film and comprises a film formed via, for example, vacuum filtration that has not undergone further processing. This term is used to distinguish the as-formed films from films that have undergone further processing such as thermal or chemical reduction to form the final composite electrode film. In an embodiment, the precursor was then removed from the Millipore filter and dried from 6-24 hours. The drying may occur in air at room temperature, or may occur at elevated temperatures. In some examples, the drying may occur in whole or in part under vacuum. In some examples, a reduction process may be further used to remove oxygen groups from the film while not reducing the dimensions of the as-formed precursor film.

The composite flexible film discussed herein thus combines the biomass-derived PCMs with large specific areas, due in part to the porosity of the walls of PCMs in combination with the hollow center. The graphene of the composite film comprises high electrical conductivity enhanced by either thermal reduction or chemical reduction, as further discussed herein. The composite film has high surface area, a porous structure, increased electronic conductivity compared to current electrode materials, and excellent flexibility. The composite film may thereby be used as an electrode in Li-ion batteries or capacitors without the use of any binder, achieving high specific capacitance, excellent rate capability and good cycling stability. The graphene content of the film improves the electrical conductivity and reduces the diffusive resistance to ion transport, which improves the rate capability. The composite film has a porous structure that results from the linkage (self-assembly) between the porous carbon microtubes and the graphene. The hierarchal porous structure of the PCMs may also contribute to electrolyte contact and accumulation of electrolyte ions, thereby enhancing the utilization efficiency and charge storage density of the composite film. The composite film may be used as an electrode in a Li-ion capacitor and is a binder-free electrode. Some capacitors including Li-ion capacitors may have unwanted internal resistance resulting from currently employed binders such as polymer binders that may be used in the fabrication of an electrode to bind the components. Thus, by employing the composite film discussed herein, the performance challenges related to binders are avoided, at least due to the self-assembly of the graphene oxide with the porous carbon microtubes.

In an embodiment, the flexible composite film formed as discussed herein may be described as a 3D macroporous film formed from the interconnection via self-assembly of graphene and porous carbon microtubes. The “self-assembly” discussed herein refers to a molecular-level spontaneous association of molecules under equilibrium conditions. During this self-assembly, which may occur upon mixing the GO with the PCMs or after a predetermined time period, the mixed materials aggregate into stable structures, in this case a film, via a plurality of non-covalent bonds. This film comprises a conductive network based on the graphene oxide. This conductive network which creates a desirable charge transfer in the film and in the electrode of the device in which it is used. The hollow microtubular structures of the PCMs may accelerate the transfer of ions. For example, a plurality of mesopores and micropores that form the basis for the porous carbon microtube porosity also promote the transfer of charge by artificial activation and store the charge, thus contributing to the overall capacity of the device in which the film is employed. Upon mixing the PCMs and GO, the self-assembly of the two components results in the interconnection and overlapping of the GO with the porous carbon microtubes in the absence of a binder. The absence of a binder decreases the internal resistance of the electrode and enhances the capacity of the device, such as an energy storage device, in which it is exposed.

The PCMs discussed herein may be fabricated using biomass fibers, by carbonizing those fibers, and activating the carbonized fibers via, for example, hydrogen phosphate (H₃PO₄) and/or KOH. This fabrication method may be employed to tune the ratio of mesoporous:microporous formations in the PCMs. In some embodiments, the resultant film is reduced by HI for from 0.1 hour (h) to about 15 h; and/or by a high temperature (500° C.-1000° C. or greater) thermal reduction, which enables the film to maintain not only the high electrical conductivity but also workable flexibility. The combination of hierarchical porous carbon microtubes comprising high specific surface areas with graphene that has excellent electrical conductivity results in the fabrication of hierarchical all-carbon nanoarchitectures without the degradation of the electron pathway and while rendering abundant interconnected meso/micropores.

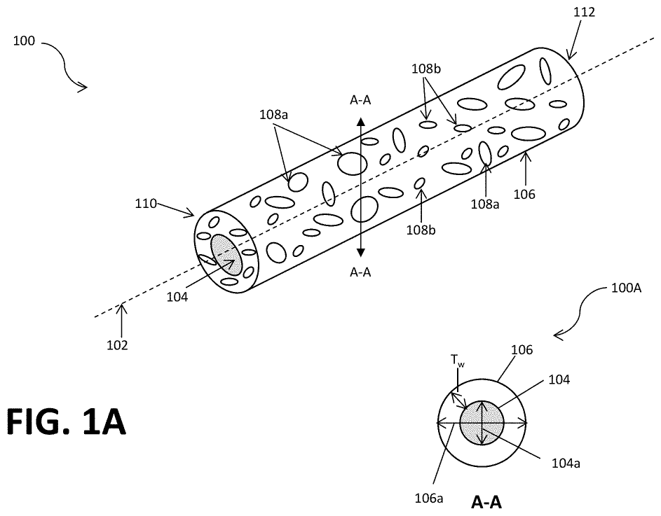

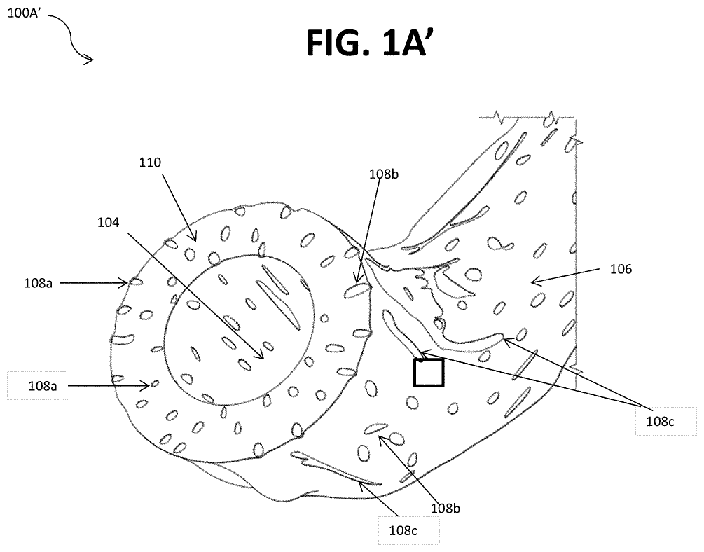

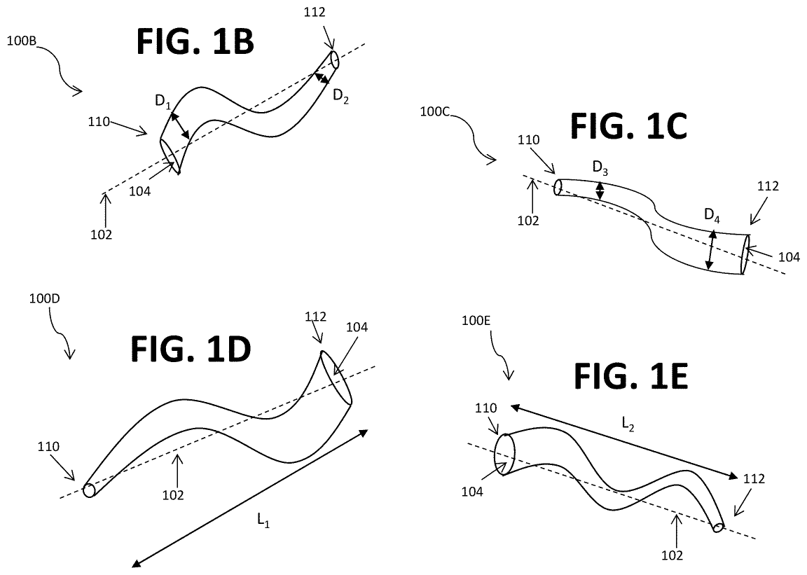

FIG. 1A is a schematic of an example PCM 100 fabricated according to embodiments of the present disclosure. While the example PCM 100 shown in FIG. 1A has a hollow center 104 extending from a first side 110 to a second side 112 that is substantially parallel to a central axis 102, this is for illustrative purposes to more easily show the micropores 108a and mesopores 108b. In practice, the PCMs may have inconsistent outside diameters and/or one or more curves, as shown in FIGS. 1B-1E and discussed below, such that the PCM is not aligned with the central axis 102. As used herein, a “mesopore” is an artificially created (e.g., by embodiments of the methods discussed herein) aperture that is made all or part of the through an inside surface of the hollow center 104 and/or the outside surface 106. Mesopores may be defined by a circular, elliptical, polygonal, or irregularly-shaped geometry. In some embodiments, a plurality of mesopores 108b and micropores 108a may join together to form network structures that extend along and/or through the walls defined by the outside surface 106 of the PCM 100. A mesopore 108b may comprise a maximum diameter from greater than about 2.1 nm to about 5 nm. The PCMs formed herein also comprise microporous holes 108a, these through-holes may be less than 2 nm in diameter. In one example, the plurality of mesopores 108b may have an average diameter from about 2.1 nm to about 34 nm and the plurality of micropores 108a may have an average diameter from about 0.95 nm to about 2 nm. The cross-section A-A of FIG. 1A is employed herein to illustrate a consistent diameter 104a of the hollow center 104 and the consistent outside diameter 106a of the outside surface 106 (e.g., the outside diameter). A wall thickness T_{w} may be calculated by the difference between 104a and 106a.

FIG. 1A′ is a magnified view of an end of a porous carbon microtube 100A′. In FIG. 1A′, the hollow center 104 is shown, and the porous carbon microtube 100A′ is shown for a portion of the microtube. FIG. 1A′ illustrates that the hierarchy of pores comprises a plurality of mesopores 108b, a plurality of micropores 108a, and a plurality of networks 108c formed by the adjacent and/or overlapping of some of the plurality of micropores 108a and/or mesopores 108b. These formations may be present on the outside surface 106, as well as on the interior of the hollow center 104 and on the sides 110 and 112 (not illustrated in FIG. 1A′).

FIGS. 1B-1E are examples of shapes of PCM 100B-100E that may result from the fabrication of the PCM. For ease of illustration, the porous nature of the PCMs 100B-100E is not shown here. The example 100 in FIG. 1A shows a PCM that is oriented with its hollow center 104 along the central axis 102. However, in other examples, the plurality of PCMs formed from natural fibers may not be rigid or straight, that is, they may be formed from fibers with natural curvature and/or obtain new or enhance existing curvature during the PCM fabrication process. Each of the PCMs 100B, 100C, 100D, and 100E comprises a hollow center 104 that is not aligned with the central axis 102. In contrast to the consistent diameters 104a and 106a discussed in FIG. 1A, the outer diameters D₁ and D₂ in FIG. 1B are not of equal size, nor are the outer diameters D₃ and D₄ in FIG. 1C. Thus, the outer diameters and inner diameters (not shown) of PCMs such as those shown in FIGS. 1B-1E may vary, as may the overall shape and curvature of the PCMs. Similarly, the length L₁ of PCM 100D may be greater than a length L₂ of another PCM 100E, and the lengths may vary among and between microtubes of a plurality of PCMs.

### Fabrication of Carbon Microtubes

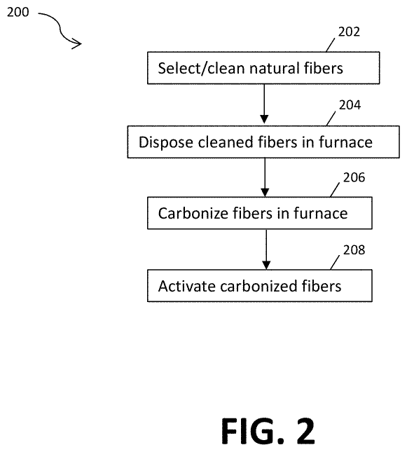

FIG. 2 is a flowchart that illustrates a method 200 of fabricating a plurality of carbon microtubes. At block 202 of the method 200, a plurality of natural fibers are selected and cleaned, for example using deionized water or another cleaning agent. The type and/or size/mass of fibers may be selected at block 202 based on a plurality of factors including desired properties of the resultant composite film and/or the target capabilities of a device in which the resultant composite film is employed. The natural fibers selected at block 202 may comprise willow catkin fibers, bamboo, kapok, cotton including long-staple cotton fibers, or other natural fibers. Long-staple cotton fibers are defined herein as those cotton fibers having an average length from about 1⅛″-1¼″. The fibers selected at block 202 may range in length (e.g., from 110 to 112 in FIG. 1A) from 3 μm to 300 μm, in thick from 0.3 to 0.7 μm, and in its inner diameter from 8 to 14 μm. The fibers selected are hollow, that is, each fiber has a through-hole extending from a first side to a second side, and are capable of forming porosity, in particular a porous structure that may be a mesoporous structure, subsequent to processing including carbonization.

At block 204, the plurality of cleaned fibers are disposed in a furnace such as a vertical tubular furnace, where, at block 206, the fibers are carbonized under an atmosphere containing nitrogen, argon, or other inert gases or combinations of inert gases. Carbonization comprises converting the fibers into carbon structures from the natural state of the fibers. In one example, at block 206, the carbonization may comprise holding the plurality of fibers in the furnace from about 300° C. to 1100° C. about for about 0.5 hour to about 4 hours, depending upon the type and quantity of fibers disposed in the furnace at block 204.

At block 208, the plurality of fibers carbonized at block 206 are removed from the furnace for activation, mixed with phosphoric acid, KOH, or another material, and disposed in a furnace for activation to form the PCM. The activation may further enhance the porous structure of the carbonized microtubes formed at block 206. In one example, the activation at block 208 may comprise adding phosphoric acid at a mass ratio between the carbonized fibers and the phosphoric acid of 1:2. The mixture is disposed in a furnace for activation, which may be performed at 500° C. for 1 h under flowing nitrogen. In this example, the furnace is cooled down to room temperature under argon flow, and chemical activation of the plurality of fibers was further performed by mixing KOH with the phosphoric acid activated product with a mass ratio of acid:carbon microtubes from about 1:1 to 4:1. This mixture was then heated to temperature of about 400° C. for 300 minutes under flowing nitrogen. As the willow catkin fibers may be used in this example, this activation forms a plurality of willow catkin-based hollow PCM. Prior to the activation at block 208, the material fabricated may be referred to as “carbonized fibers” or “carbonized microtubes.” In an alternate embodiment, at block 208, the carbonized fibers formed at block 206, which may be willow catkin fibers, were further mixed with KOH in a mass ratio of carbonized fibers to KOH from 1:1 to 6:1 and then put into a furnace for activation. In one example, the activation process was carried out at block 208 at about 900° C. for about 20 minutes under flowing nitrogen. In other examples, the activation process may occur at block 208 at from about 400° C. to about 900° C. for about 20 minutes-300 minutes under flowing nitrogen.

In an alternate embodiment, for example, when kapok fibers are selected at block 202, the carbonized fibers formed at block 206 are further mixed with KOH at a mass ratio of about 1:1 and then put into a furnace for activation. The activation process at block 208 was carried out at 600° C. for 20 minutes under flowing nitrogen. In another kapok fiber embodiment, the plurality of carbonized fibers formed at block 206 was further mixed with KOH in the mass ratio of fibers:KOH of 1:3 and then put into an activated furnace. The activation process was carried out at 600° C. for 20 minutes under flowing nitrogen. In another embodiment, the carbonized materials, for example, when cotton is selected at block 202, were further mixed with phosphoric acid at a mass ratio of carbonized fibers to phosphoric acid of about 1:5 and then put into an activated furnace. The activation process was carried out at 400° C. for 300 minutes under flowing nitrogen. Subsequent to carbonization at block 206 and activation at block 208, the pluralities of fibers comprise a mesoporous structure such that the carbonized fibers are microtubes that have tubular structures and a plurality of mesopores and/or micropores including networked micro- and/or mesopores formed through the walls of the microtubes.

### Fabrication of PCM, Composite Film Precusor, and Composite Film

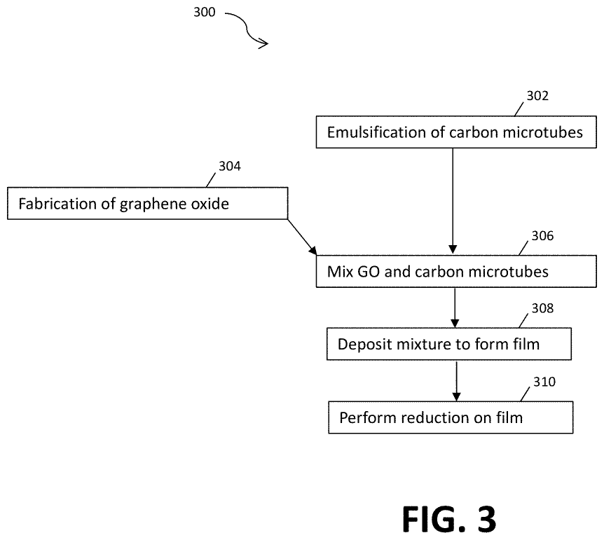

FIG. 3 is a flow chart that illustrates a method 300 of fabricating a composite electrode film from carbon microtubes. In an embodiment, at block 302, the plurality of PCMs obtained, for example, from willow catkins, in the method 200 subsequent to the activation at block 208 was dispersed in N, N-Dimethylformamide by emulsification with a concentration up to 2 mg/ml of the N, N-Dimethylformamide. At block 304, which may occur at any point in the process 300, including prior to the initiation of either methods 200 or 300, a quantity of graphite oxide prepared by the modified Hummers' method was dispersed in water by sonication under 300 Watts (W) for 30 minutes. The Hummers' method may be used to fabricate graphite oxide, which comprises carbon (C), oxygen (O), and (H), via forming a solution of sulfuric acid, sodium nitride, and graphite, and adding potassium permanganate to form a compound with a range of the ratio of C:O from about 1.35 to about 1.45. In some examples, a modification of the Hummers' method may employ the use of ultrasonic technology and exfoliation to form the graphite oxide. The Hummers' method, the modified Hummers' method, or other methods may be used to fabricate the GO flakes discussed herein. The GO flakes are two-dimensional, single-layer structures with an at least one maximum diameter from about 0.1 microns to about 50 microns, which self-assemble with the PCM as discussed herein to form the precursor film.

The resulting mixture comprises a graphene oxide (GO) hydrosol with a concentration of 0.5 mg/mL, this form of GO may be referred to as “GO flakes” and are two-dimensional materials. Subsequently, at block 306, both the GO flakes and the plurality of PCMs formed, for example, via the method 200, are mixed together according to a mass ratio m_{PCM}:m_{GO} of about 1:1 to form a mixture. That is, in one example, 50% of a mass of the mixture is GO flakes (graphene oxide hydrosol) and 50% of the mass is PCM.

In another example of the method 300, at block 302, after the activation at block 208 in the method 200 of FIG. 2, the plurality of PCMs obtained, for example, from willow catkins, at block 208 were dispersed in N, N-Dimethylformamide at a concentration of about 0.1 mg/ml. At block 304, a quantity of graphite oxide was prepared by an electrochemical oxidation process where the graphite oxide was dispersed in water by sonication under 100 W for 90 minutes to obtain graphene oxide (GO) hydrosol at a concentration of 10 mg/mL. Subsequently, at block 306, both the GO flakes and the plurality of willow catkin-based hollow PCMs were mixed according to a mass ratio m_{PCM} m_{GO} of 1:30.

In an alternate embodiment, at block 302, after the activation at block 208 in the method 200 of FIG. 2, the plurality of kapok-based PCMs is dispersed in ethanol by emulsification to form a mixture with a concentration from 1 mg/ml to 7 mg/ml. In one example, the concentration of PCM in ethanol is about 5 mg/ml. At block 304, a quantity of graphite oxide prepared by the modified Hummers' method was dispersed in water by sonication under 1000 W for 5 minutes. The resultant compound is a graphene oxide (GO) hydrosol (GO flakes) with a concentration of 0.1 mg/ml. Next, at block 306, both the GO flakes and kapok-based hollow PCMs were mixed according to a mass ratio m_{PCM}:m_{GO} of 1.0:0.1.

In another embodiment, at block 302, the plurality of kapok-based PCMs formed in an embodiment of the method 200 was dispersed in N, N-Dimethylformamide by emulsification to form a concentration of about 0.1 mg/ml. At block 304, a quantity of graphite oxide prepared by the modified Hummers' method was dispersed in water by sonication under 1000 W for 5 minutes to form graphene oxide (GO) hydrosol with a concentration of 2 mg/ml. Subsequently, at block 306, both the GO flakes and kapok-based hollow PCMs are mixed according to a mass ratio of m_{PCM}:m_{GO} of 1:5.

In an alternate embodiment, after activation, at block 208 in the method 200, the long-staple cotton-based PCMs are dispersed at block 302 in N, N-Dimethylformamide by emulsification with a concentration up to 0.1 mg/ml. A quantity of graphite oxide prepared by the modified Hummers' method was dispersed in water by sonication at block 304 under 1000 W for 5 minutes to get the graphene oxide (GO) hydrosol with a concentration of 2 mg/ml. Subsequently, at block 306, both the GO flakes and long-staple cotton carbon microtubes are combined according to the mass ratio m_{PCM}:m_{GO} of 1:1.5. It is to be appreciated that the mixing of carbon microtubes from various base materials along with the GO includes a self-assembly of the microtubes and the GO, as discussed above, such that, at block 308, the mixture may be disposed as a film. The formation of a film at block 308 may comprise depositing the mixture on at least one surface of a filter membrane during vacuum filtration. The deposition of this mixture at block 308 may occur in one or more layers or depositions steps, and the film formed at block 308 may be referred to as the as-deposited or as-formed film, or as a composite film precursor, since additional processing at block 310 may be performed.

In an embodiment, at block 310, the film formed at block 308 may be disposed between at least two plates, one on each side of the film, and the assembly is annealed in a process that may be referred to as “reduction” in order to enhance the electrical conductivity of the film. In one example, at block 310, the film-plate assembly was annealed at about 1000° C. for 2 h in a tube furnace under flowing nitrogen to form a flexible composite film. In other examples, the reduction at block 310 may comprise annealing the film between the at least two graphite plates from 500° C. for 15 h under nitrogen, or at 1000° C. for 0.1 h. In still other examples, hydrogen iodide (HI) is used for reduction. In one example, the HI reduction may be performed by immersing the as-fabricated film in HI solution of a molar concentration from about 30% to about 60%, in some embodiments a 45% molarity solution may be used. The as-fabricated film may be immersed in the HI at room temperature, which is defined herein as 20-25° C. (68-77° F.), for a period from 6 hours to 18 hours. In alternate embodiments, the immersion may occur for 12 hours.

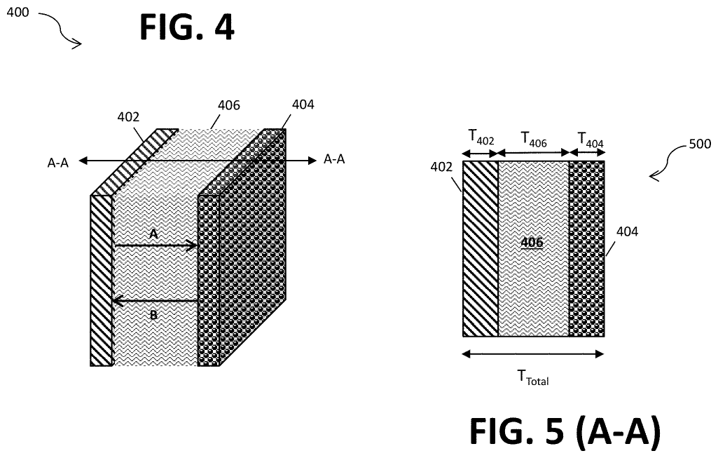

FIG. 4 is a partial schematic illustration of a capacitor 400 comprising a composite film fabricated according to embodiments of the present disclosure. In particular, FIG. 4 shows a first electrode 402 and a second electrode 404, as well as a region 406 that may comprise molten salt, electrolyte solution, electrolyte solid, or another material capable of transferring charge. In a battery, an electrically insulating porous material such as a separator can be used to retain any electrolyte while preventing direct electrical contact between the two electrodes 402, 404 that could result in short circuiting between the two electrodes 402, 404. In a capacitor, the region 406 may comprise a material having a high dielectric constant to serve as the separator between the electrodes 402, 404. The first electrode 402 may comprise lithium, for example, intercalated lithium, and the second electrode 404 may comprise the composite film discussed herein. In particular, the second electrode 404 may comprise graphene oxide and PCMs. In one example, the second electrode 404 consists only of those components in various ratios as discussed above and does not contain additional components such as binders.

FIG. 5 is a partial cross-section 500 of section A-A from FIG. 4 of the capacitor 400 shown in FIG. 4. In FIG. 5, the cross-section 500 shows the first electrode 402 comprising a thickness T₄₀₂, the region 406 comprises a thickness T₄₀₆, and the second electrode 404 comprises a thickness T₄₀₄ that may be from 20 microns to 100 microns. While the thickness T₄₀₂ is illustrated as being similar to the thickness T₄₀₄ in FIG. 5, in alternate embodiments, the thicknesses of each electrode 402 and 404 may not be similar. In addition, based upon the medium used, the thickness T₄₀₆ may be referred to as the distance T₄₀₆ between the first electrode 402 and the second electrode 404, and may vary from 10 μm to 30 μm.

Turning back to FIG. 4, the first electrode 402 may be the positive electrode, configured to send electrons to the second, negative electrode 404 during charging along path A via the media 406. The negative electrode 404 sends the electrons back to the positive electrode 402 via the medium 406 during discharging along path B. During this movement, the lithium ions maintain a stored charge with potential but may not move.

### Example Methods of Fabricating GO/PCM Composite Films

### Example 1

A plurality of clean willow catkin fibers were disposed in a vertical tubular furnace and carbonized under a nitrogen atmosphere. This carbonization was performed by heating the plurality of clean willow catkin fibers at 500° C. for 3 h to obtain the carbonized fibers. Phosphoric acid was then added to the carbonized fibers with a mass ration between the carbonized fibers and the phosphoric acid of 1:2. The mixture of carbonized materials and phosphoric acid was subsequently disposed in a furnace for activation. The activation was carried out at 500° C. for 1 h under flowing nitrogen. Then the furnace was cooled down to room temperature under argon flow. After that, chemical activation of the plurality of fibers was further performed by mixing KOH with the above-mentioned phosphoric acid activated product with a mass ratio of the mass of the combination of KOH and phosphoric acid to the mass of the carbonized fibers of 1:1. This mixture was heated to temperature of about 400° C. for 300 minutes under flowing nitrogen to form a plurality of willow catkin-based hollow PCMs. For ease of use, the plurality of carbon microtubes obtained subsequent to this heat treatment was dispersed in N, N-Dimethylformamide by emulsification with a concentration up to 2 mg/ml of the N, N-Dimethylformamide. A quantity of graphite oxide prepared by the modified Hummers' method was dispersed in water by sonication under 300 W for 30 minutes to obtain a graphene oxide (GO) hydrosol with a concentration of 0.5 mg/mL that may be referred to as “GO flakes”. Subsequently, both the GO flakes and the plurality of carbon microtubes, are mixed together according to the mass ratio of m_{PCM}:m_{GO} of 1:1. This mixture is deposited randomly in at least one layer and overlapped onto the surface of a filter membrane during vacuum filtration to obtain a composite film precursor.

In an embodiment, in order to further enhance the electrical conductivity of the composite film via the precursor, a reduction process is performed. In this example, the reduction process comprises disposing the as-formed composite film precursor between at least two graphite plates. As used herein, an “as-formed” composite film or composite film precursor is a GO/PCM film which has been formed from the mixture but which has not yet undergone reduction. During reduction, the film-plate assembly was annealed at about 1000° C. for 2 h in a tube furnace under flowing nitrogen to form a flexible composite film. In this example, the final composite flexible film showed a specific area of 590 m²/g. When the composite film formed in this example was used as the electrode of Li-ion capacitor, the capacitor exhibited a specific capacitance of 90 F/g at a current density of 1 mA/cm² 1 M LiPF₆. After about 3000 cycles of the capacitor, the specific capacitance maintained the initial capacity of 95.6%.

### Example 2

In another example, a plurality of clean willow catkin was disposed in a vertical tubular furnace and carbonized under a nitrogen atmosphere by heating at 1000° C. for 1 h. The obtained carbonized fibers were further mixed with KOH in a mass ratio of carbonized fibers:KOH of 1:6 and then put into a furnace for activation. The activation process was carried out at 900° C. for 20 minutes under flowing nitrogen. After activation, a plurality of willow catkin-based hollow mesoporous carbon microtubes were obtained, and the plurality of carbon microtubes was dispersed in N, N-Dimethylformamide with a concentration of about 0.1 mg/ml. A quantity of graphite oxide was prepared by an electrochemical oxidation process where it was dispersed in water by sonication under 100 W for 90 minutes to obtain graphene oxide (GO) hydrosol at a concentration of 10 mg/mL. Next, both the GO flakes and the plurality of willow catkin-based hollow mesoporous carbon microtubes were mixed according to a mass ratio of m_{PCM}:m_{GO} of 1:30. This mixture was disposed in one or more layers onto the surface of a filter membrane during vacuum filtration to obtain a composite film precursor. To further enhance the electrical conductivity, a reduction process was performed on the composite film precursor. The as-formed composite film precursor was placed between graphite plates and annealed at 500° C. for 15 h in a tube furnace under flowing nitrogen. The final composite flexible film resulting from the reduction process comprised a specific area of 610 m²/g. When the composite film was used as the electrode of Li-ion capacitor, it exhibited a specific capacitance of 81 F/g at a current density of 1 mA/cm² 1 M LiPF₆. After 3000 cycles, the specific capacitance can still retain the initial capacity of 95.4%.

### Example 3

In another example, a plurality of cleaned kapok fibers were disposed in a vertical tubular furnace and carbonized under a nitrogen atmosphere by heating at 400° C. for 3 h. The obtained carbonized materials was further mixed with KOH in the mass ratio of 1:1 and then put into a furnace for activation. The activation was carried out at 600° C. for 20 minutes under flowing nitrogen. After activation, the plurality of kapok-based hollow PCMs was dispersed in ethanol by emulsification with a concentration up to 5 mg/ml. A quantity of graphite oxide prepared by the modified Hummers' method was dispersed in water by sonication under 1000 W for 5 minutes to get the graphene oxide (GO) hydrosol with a concentration of 0.1 mg/mL. Next, both the GO flakes and kapok-based hollow mesoporous carbon microtube were mixed according to the mass ratio of m_{PCM}:m_{GO} of 1:0.1. This mixture was deposited in one or more layers onto the surface of filter membrane during vacuum filtration to obtain a composite film precursor. To further enhance the electrical conductivity, a reduction process is performed where the as-formed composite film precursor was disposed between graphite plates and annealed at 1000° C. for 0.1 h in a tube furnace under flowing nitrogen. The final composite flexible film showed a specific area of 215 m²/g. When the composite film was used as the electrode of Li-ion capacitor, it exhibited a specific capacitance of 74 F/g at a current density of 1 mA/cm²1 M LiPF₆. After 3000 cycles, the specific capacitance maintained the initial capacity of 95%.

### Example 4

A plurality of cleaned kapok fibers were placed in a vertical tubular furnace and carbonized under a nitrogen atmosphere by heating at 600° C. for 3 h. The plurality of carbonized fibers was further mixed with KOH in the mass ratio of 1:3 and then put into an activated furnace. The activation process was carried out at 600° C. for 20 minutes under flowing nitrogen. After activation, the plurality of kapok-based hollow PCM was dispersed in N, N-Dimethylformamide by emulsification to form a concentration of about 0.1 mg/ml. A quantity of graphite oxide prepared by the modified Hummers' method was dispersed in water by sonication under 1000 W for 5 minutes to form graphene oxide (GO) hydrosol with a concentration of 2 mg/mL. Next, both the GO flakes and kapok-based hollow mesoporous carbon microtubes are mixed according to a mass ratio of m_{PCM}:m_{GO} of 1:5 and deposited in one or more layers onto the surface of filter membrane during vacuum filtration to obtain a composite film precursor. To further enhance the electrical conductivity, a reduction of the precursor film may be employed. So the as-formed composite film precursor was further reduced by hydrogen iodide (HI) reduction. In one example, the HI reduction may be performed by immersing the as-fabricated film in HI solution of a molar concentration from about 30% to about 60%, in some embodiments a 45% molarity solution may be used. The as-fabricated film may be immersed in the HI at room temperature, defined herein as 20-25° C. (68-77° F.), for a period from 6 hours to 18 hours, in some embodiments, the immersion may occur for 12 hours. The final composite flexible film showed a specific area of 486 m²/g. When the composite film was used as the electrode of Li-ion capacitor, it exhibited a specific capacitance of 93 F/g at a current density of 1 mA/cm²1 M LiPF₆. After 3000 cycles, the specific capacitance can still retain the initial capacity of 96.2%.

### Example 5

A plurality of clean long-staple cotton fibers were disposed in a vertical tubular furnace and carbonized under a nitrogen atmosphere by heating at 400° C. for 3 hours. The obtained carbonized materials was further mixed with phosphoric acid in the mass ratio of 1:5 and then put into a furnace. The activation process was carried out at 400° C. for 300 minutes under flowing nitrogen. After activation, the plurality of long-staple cotton-based hollow mesoporous carbon microtubes formed as a result of activation was dispersed in N, N-Dimethylformamide via emulsification at a concentration up to 0.1 mg/ml. A plurality of GO flakes were prepared using graphite oxide prepared by the modified Hummers' method was dispersed in water by sonication under 1000 W for 5 minutes. The resultant graphene oxide (GO) hydrosol is formed with a concentration of 2 mg/mL. Next, both the GO flakes and long-staple cotton-based hollow mesoporous carbon microtubes, according to the mass ratio of m_{PCM}:m_{GO} of 1:1.5, are deposited randomly and overlapped onto the surface of filter membrane during vacuum filtration to obtain a composite film precursor. To further enhance the electrical conductivity, the reduction process is employed. So the as-formed composite film precursor was further reduced by HI reduction. Subsequent to reduction, the composite film showed a specific area of 542 m²/g.

When the composite film was used as the electrode of Li-ion capacitor, it exhibited a specific capacitance of 85 F/g at a current density of 1 mA/cm²1 M LiPF₆. After 3000 cycles, the specific capacitance can still retain the initial capacity of 97%.

TABLE 1
Properties of the samples of composite film layer(s)

| | Thermal reduction - | | | | | |
|---|---|---|---|---|---|---|
| | thickness | | | | | |
| Samples | before | after | Resis- | Weight | Specific | |
| based | reduc- | reduc- | tance | Yield | surface | Tensile |
| embodi- | tion | tion | (Ω · | after | area | strength |
| ment | (μm) | (μm) | cm) | reduction | (m²/g) | (MPa) |
| Example 1 | 56 | 56 | 0.032 | 52.5% | 590 | 2.97 |
| Example 2 | 73 | 73 | 0.1 | 48.1% | 610 | 2.9 |
| Example 3 | 65 | 65 | 0.032 | 44.3% | 215 | 3.01 |
| Example 4 | 60 | 60 | 0.069 | 45.6% | 486 | 6.61 |
| Example 5 | 79 | 79 | 0.044 | 45.3% | 542 | 6.48 |

Reduction processes such as the HI reduction process may remove the abundant oxygen groups on the surface of composite films, but not affect the thickness of the film. Thus, the final composite films maintain the same thickness before and after reduction. Yet, as indicated by the “Weight Yield After Reduction” field in Table 1 the weight of composite film decreased due to the decomposition of abundant oxygen groups on the surface of composite films in response to the reduction.

TABLE 2
Volume of Micropores (V_{micro}) as compared
to the total volume (Vₜₒₜₐₗ)

| | Specific surface | V_{micro} | Vₜₒₜₐₗ | V_{micro}/Vₜₒₜₐₗ |
|---|---|---|---|---|
| | area/m²/g | (cm³/g) | (cm³/g) | (%) |
| Example 1 | 590 | 0.17 | 0.46 | 36.9 |
| Example 2 | 610 | 0.18 | 0.79 | 22.8 |
| Example 3 | 215 | 0.06 | 0.19 | 31.6 |
| Example 4 | 486 | 0.14 | 0.54 | 25.9 |
| Example 5 | 542 | 0.16 | 0.80 | 20.0 |

The total volume (Vₜₒₜₐₗ) of Table 2 is the average total volume across a plurality of carbon microtubes fabricated according to the different examples above, the Vₜₒₜₐₗ is a result of the hollow nature of the porous carbon microtubes in combination with the porous walls of the microtubes, which promotes charge transfer as discussed above. The V_{micro} is the volume of the micropores as compared to the total volume (Vₜₒₜₐₗ).

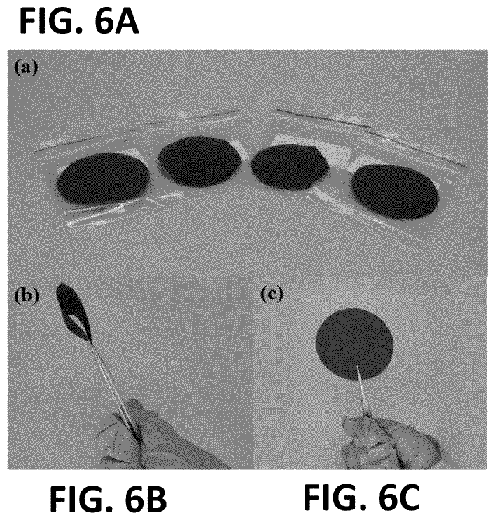

FIGS. 6A-6C are photographs of as-formed composite films according to various embodiments of the present disclosure. FIG. 6A shows four films fabricated according to examples 1-4 above in a “flat” or unbent state. FIG. 6B is an image of the as-formed composite film fabricated according to example 1 above in a bent state, folded in approximately half. FIG. 6C illustrates that the film is flexible enough to return to its original flat, unbent state prior to folding in FIG. 6B.

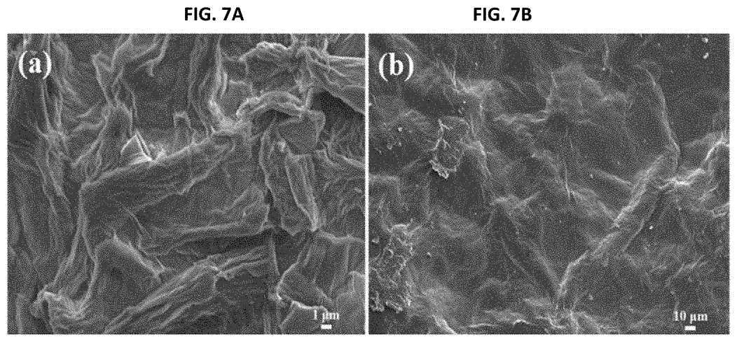

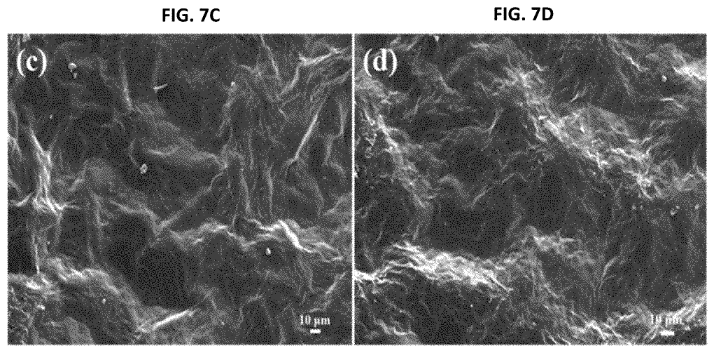

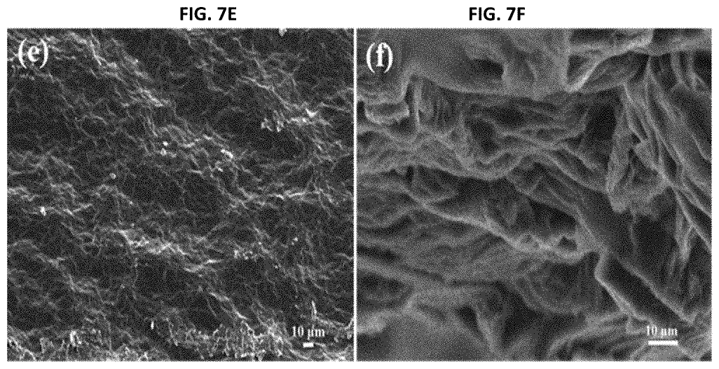

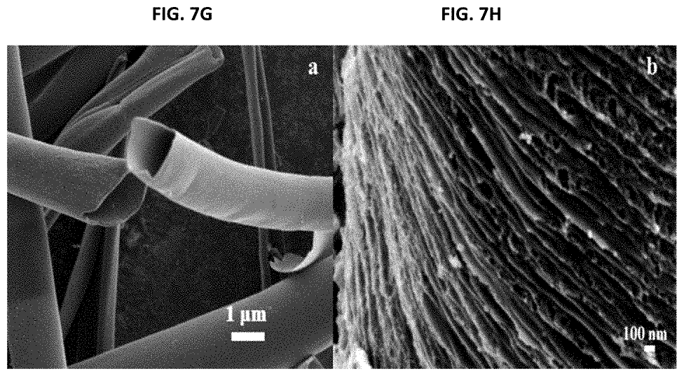

FIGS. 7A-7F are scanning electron microscopy (SEM) images of as-formed composite films (e.g., prior to reduction) fabricated according to certain embodiments of the present disclosure. FIG. 7A is an SEM image of an as-formed composite film fabricated according to the method of Example 1; FIG. 7B is an SEM image of an as-formed composite film fabricated according to the method of Example 2; FIG. 7C is an SEM image of an as-formed composite film fabricated according to the method of Example 3; FIG. 7D is an SEM image of an as-formed composite film fabricated according to the method of Example 4; and FIG. 7E is an SEM image of an as-formed composite film fabricated according to the method of Example 5.

These SEM images of all the as-obtained composite films based on various embodiments show that the biomass fiber-based carbon microtubes are wrapped by three-dimensional graphene sheets, the three-dimensionality appearing as “wrinkles” on the surface such that the self-assembly of the GO and PCM forms the three-dimensional structure which contributes to the surface area measurement. Additionally, the structure of microtubes may be viewed, indicating the efficient hybrid of biomass fiber-based microtube with graphene in films manufactured via these example methods. To show the heterogeneous assembly and the coexistence of the biomass fiber-based microtube and graphene, a cross sectional SEM image of the composite film based on Example was obtained as shown FIG. 7F. FIG. 7F illustrates the porous carbon microtubes with graphene loading on its inner and outer wall interconnect to form a loose assembled 3D structure. In the composite film, the naturally selected tube combined with artificially created pore structure provides a fast diffusion channel for electrolyte ions, while the existence of graphene greatly improves its conductivity.

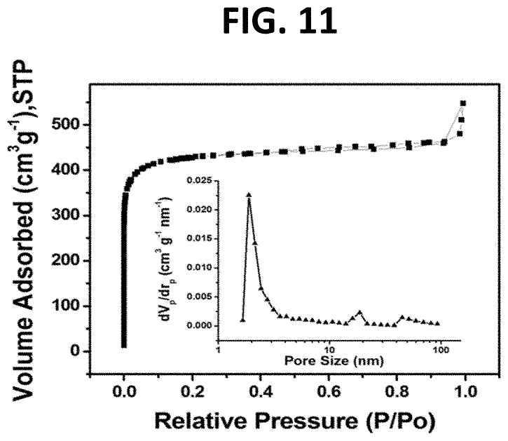

FIGS. 7G and 7H are SEM images of raw hollow fibers and before and after activation. As shown in FIG. 7G, the carbon microtubes inherit the natural hollow microtubular morphology of biomass fiber. While mesopores and micropores on the surface of carbon microtubes were created by the activation treatment, as shown in FIG. 7H. The production of both mesopores and micropores may occur during the activation block or blocks of embodiments of methods as discussed herein. The hierarchical porous structure, integrated abundant mesopores and micropores into hollow microtubular, is favorable for electrolyte ions fast diffusion within the electrode and thus achieved enhanced electrochemical performances. FIG. 11 is a graph of the volume absorbed v. relative pressure obtained from N₂ adsorption-desorption isotherm measurements. In particular, FIG. 11 shows these measurements on a specific surface area (1775.7 m² g⁻¹).

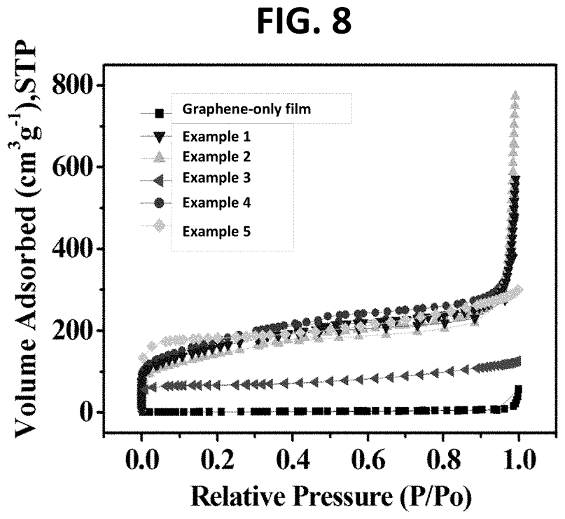

FIG. 8 is a graph of a plurality of absorption-desorption curves of as-formed composite films fabricated according to certain embodiments of the present disclosure. In particular, FIG. 8 shows the volume absorbed and the relative pressure applied to as-formed composite films fabricated via the methods of examples 1-5. As shown in FIG. 8, the response of the films fabricated according to examples 1, 2, 4, and 5 had similar absorption volumes resulting from the testing, in contrast to example 3 (which used kapok fibers) and the GO-only film that did not contain carbon microtubes.

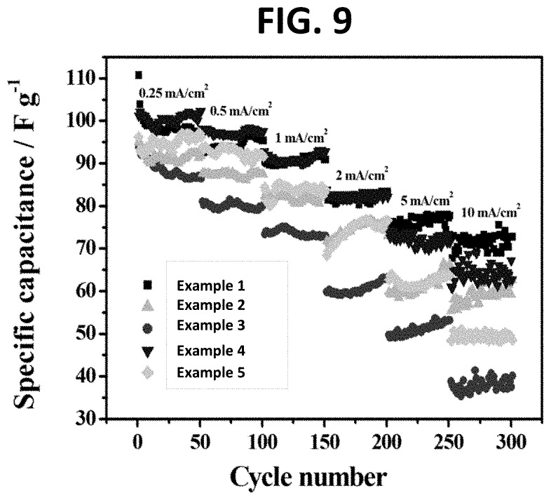

FIG. 9 is a graph of a plurality of results of cycling films fabricated according to Examples 1-5 to illustrate the rate capability. The rate or rated capability is a maximum charge/discharge rate of a device, or, as shown in FIG. 9, of as-fabricated films. As shown in FIG. 9, a plurality of current densities ranging from 0.25 mA/cm² to about 10 mA/cm². For example, a current density of 0.25 mA/cm² was used during the first 50 (0-50) cycles, 0.5 mA/cm² was used for the next 50 cycles, then 1 mA/cm², 2 mA/cm², 5 mA/cm², were each used for subsequent sets of about 50 cycles, and a current density 10 mA/cm² was used for the final 50 cycles, e.g., up until the 300^{th} cycle.

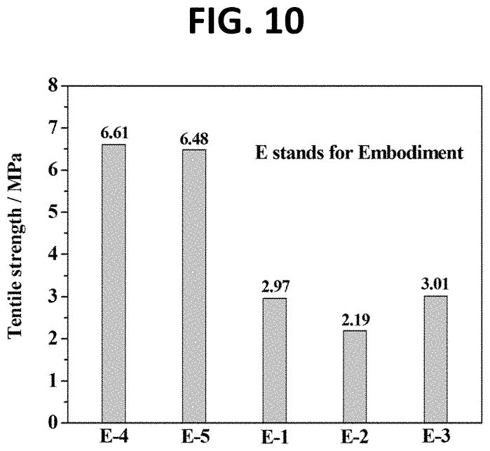

FIG. 10 illustrates the tensile strength, e.g., the resistance of a material to breaking under tension force, in MPa of samples of the composite film subsequent to reduction according to the Examples 1-5 discussed herein. Films E-1, fabricated according to the method of example 1, E-2 fabricated according to the method of example 2, E-3 fabricated according to the method of example 3, E-4 fabricated according to the method of example 4, E-5 fabricated according to the method of example 5, were tested for tensile strength to determine the relative flexibility of the films made according to the various methods in the examples 1-5. As shown in FIG. 10, depending upon the tensile strength (and associated flexibility) desired from a composite film, the different fabrication methods may be used and/or tuned to produce that target value or range of value. For example, the tensile strength of the composite films formed via the methods in example 4 and example 5 are about 6.61 MPa and 6.48 MPa, respectively, which is higher than either that of the film based on thermal reduction or that of a pure graphene film. Thus, in some examples, a chemical reduction may produce a more flexible as-formed film than a thermal reduction.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of fabricating carbon microtubes, comprising:
disposing a plurality of fibers in a vacuum furnace;
subsequently, activating the plurality of fibers, wherein activating the plurality of fibers comprises combining the plurality of fibers with an aqueous solution to form a mixture; and
forming, in response to the activating, a plurality of porous carbon microtubes, wherein each microtube of the plurality of porous carbon microtubes, is hollow, and comprises a porous surface.

2. The method of claim 1, wherein the plurality of porous carbon microtubes comprise an average length from about 3 μm to about 300 μm.

3. The method of claim 1, wherein the plurality of porous carbon microtubes comprise an average wall thickness from about 0.3 μm to about 0.7 μm, and an inner diameter from about 8 μm to about 14 μm.

4. The method of claim 1, wherein the plurality of plant fibers comprise at least one of cotton, willow catkin, or kapok.

5. The method of claim 1, wherein the carbonizing comprises disposing the plurality of fibers in a furnace and holding the plurality of fibers in the furnace from 300° C. to 1100° C. about for about 0.5 hour to about 4 hours.

6. The method of claim 1, wherein the aqueous solution comprises KOH or phosphoric acid.

7. The method of claim 1, wherein the activating further comprises holding the mixture from about 10 minutes to about 400 minutes from about 400° C. to about 1100° C.

8. The method of claim 1, wherein a portion of the plurality of carbon microtubes comprises a centerline comprising at least one smooth curve and is not aligned along a central axis.

9. The method of claim 1, wherein each carbon microtube of the plurality of carbon microtubes comprises a plurality of mesopores and a plurality of micropores, wherein at least some of the mesopores of the plurality of mesopores are adjacent to and connected to at least some of the micropores of the plurality of micropores to form a network.

10. The method of claim 1 wherein activating the plurality of fibers comprises disposing the fibers in an aqueous solution in a predetermined mass ratio of fibers:solution from 1:1 to 1:10.

11. A method of fabricating an electrode film, comprising:
forming a mixture of a 2-dimensional material and a plurality of carbon microtubes, wherein the 2-dimensional material and the plurality of carbon microtubes self-assemble in response to mixing;
forming, via vacuum filtration, a precursor film, by disposing the mixture on a membrane in a vacuum filtration apparatus; and
reducing the precursor film to form the composite film.

12. The method of claim 11, wherein, subsequent to the reducing, the composite film comprises a tensile strength from about 2.9 MPa to about 6.5 MPa.

13. The method of claim 11, wherein forming the mixture comprises forming a mass ratio in the colloidal dispersion of the plurality of porous carbon microtubes, 2-dimensional material (m_{PCM}:m_{2D}) from about 0.1 to about 30.1.

14. The method of claim 11, wherein the 2-dimensional material comprises graphene oxide (GO).

15. The method of claim 11, wherein reducing the precursor film comprises immersing the precursor film in hydrogen iodide (HI).

16. The method of claim 11, wherein reducing the precursor film comprises: disposing the precursor film between at least two plates to form an assembly; and annealing the assembly.

17. The method of claim 11, wherein the precursor film comprises a first weight and a first thickness and wherein the composite film comprises a second weight and the first thickness, wherein the second weight is from about 40% to about 60% of the first weight.

18. The method of claim 11, wherein the mixture does not comprise a binder.

19. A device comprising:
a first electrode comprising a conductive, flexible, composite film comprising graphene oxide (GO) and a plurality of carbon microtubes, wherein the plurality of microtubes are hollow and comprise porous walls; and
a second electrode;
wherein an electrolyte solution, electrolyte solid, or a molten salt is disposed between the first plate and the second plate.

20. The device of claim 19, wherein the first electrode comprises a thickness from about 50 microns to about 80 microns and a tensile strength from about 2.9 MPa to about 6.5 MPa.
